(19) United States
(12) Patent Application Publication
(10) Pub. No.: US 2009/0238546 A1
(43) Pub. Date: Sep. 24, 2009

(54) Stereoscopic viewing device and method of displaying stereoscopic images

(76) Inventor: Lei Zhong, Guangdong (CN)

Correspondence Address: SAM CHEN, 7F-1, 293, ROOSEVELT ROAD, SEC 3, TAIPEI, TW

(21) Appl. No.: 12/439,686

(22) PCT Filed: Sep. 4, 2007
(86) PCT No.: PCT/CN2007/002642

§ 371 Date: Mar. 3, 2009

(30) Foreign Application Priority Data
Sep. 4, 2006 (CN) 200610062410.4
Aug. 1, 2007 (CN) 200710075463.4

(51) Int. Cl. H04N 5/00; G02B 27/22; H04N 13/04

(52) U.S. Cl. 386/126; 359/473; 359/471; 348/51; 348/E13.001; 386/E05.064

(57) ABSTRACT

A stereoscopic viewer includes a transverse rack; left and right sections comprising a fixed eyepiece, a turn plate, a pinion engaging teeth of the track and rotatably disposed on the turn plate, and an objective rotatably disposed on the pinion; and an adjustment screw engaging the teeth of the rack. A first beam of light coming from one of human eyes reaching and being reflected by the eyepiece of the left section, reaching and being reflected by the objective of the left section, and projects onto a left portion of a display. A second beam of light coming from the other one of the human eyes reaching and being reflected by the eyepiece of the right section, reaching and being reflected by the objective of the right section, and projects onto a right portion of the display. A 3-D image is given to the human eyes on the display.

### BACKGROUND OF THE INVENTION

1. Field of Invention

The invention relates to stereoscopic viewing devices and more particularly to such a stereoscopic viewing device with improved characteristics and a method of either displaying stereoscopic images in cooperation with a computer picture viewing software or displaying stereoscopic DVD (Digital Video Disc) video clips/films in cooperation with a DVD player both by means of the stereoscopic viewing device.

2. Description of Related Art

Typically, binocular stereoscopic viewing devices can impart two slightly different images to both of a user's eyes respectively resulting in the mental image being a three dimensional (3-D) one. A number of hand held or head mounted displays incorporating the above technique have been commercially available.

Nowadays, more and more people enjoy the fun of watching big screen TV or viewing pictures or films played on a computer LCD (liquid crystal display) display. However, the above technique and the conventional hand held or head mounted displays are not suitable for showing 3-D images, films, or motion pictures on, for example, the big screen TV. This is because resolution may be reduced greatly on the big LCD screen and unfortunately the reduced resolution can be restored.

Chinese Patent Number 200410000039.X discloses a stereoscopic viewer for LCD display in which a prism is used to disperse light and thus creates a 3-D illusion from a pair of 2D images. However, image distortion is a serious problem of the viewer. Another Chinese Patent Number 200520016766.5 discloses a 3-D imaging device. Unfortunately, its optical aberration is serious. Thus, improvements still exist.

### SUMMARY OF THE INVENTION

It is therefore one object of the invention to provide a stereoscopic viewing device comprising: a transverse rack; left and right sections comprising a fixed first eyepiece, a turn plate, a pinion engaging teeth of the track and rotatably disposed on the turn plate, and an objective rotatably disposed on the pinion; and a first adjustment screw engaging the teeth of the rack, wherein a first beam of light coming from one of human eyes reaching and being reflected by the first eyepiece of the left section, reaching and being reflected by the objective of the left section, and projects onto a left portion of a display; wherein a second beam of light coming from the other one of the human eyes reaching and being reflected by the first eyepiece of the right section, reaching and being reflected by the objective of the right section, and projects onto a right portion of the display; wherein a 3-D image is given to the human eyes when the first and second beams of light project on the display; and wherein the first adjustment screw is adapted to turn to linearly move the rack which rotates the pinions to adjust angles of the objectives.

It is another object of the invention to provide a method of displaying stereoscopic images on a display in cooperation with a computer and the stereoscopic viewing device, comprising the steps of (a) dividing a monitor of the computer into first and second portions and a gap therebetween; (b) running a picture viewing software on the computer; (c) choosing a first picture from a storage device of the computer and showing same on the first portion of the monitor of the computer; (d) instructing the computer to search a second picture having the same file name ad file size as the first picture from the storage device; (e) downloading the first picture and the found second picture into a memory of the computer to record as a picture file with a unique serial number and showing the second picture on the second portion of the monitor of the computer; and (f) playing one of the picture files and operating the stereoscopic viewing device in cooperation with the computer such that a person viewing the display is able to see a 3-D image being rendered thereon.

It is a further object of the invention to provide a method of displaying a stereoscopic DVD film on a display in cooperation with a DVD player and the stereoscopic viewing device of claim 1, comprising the steps of (a) adding a time frame in each recorded picture of the film; (b) comparing the time frames of the paired pictures of the film; (c) causing the picture being recorded earlier to wait for the other picture of the same pair if it is lag in time; and (d) showing the paired pictures on left and right portions of the display at about the same time such that a person viewing the display is able to see a 3-D image being rendered thereon.

The above and other objects, features and advantages of the invention will become apparent from the following detailed description taken with the accompanying drawings.

### BRIEF DESCRIPTION OF THE DRAWINGS

FIG. 1 schematically shows a stereoscopic viewing device according to the invention, a flat display in cooperation therewith, and beams of light in use;

FIG. 2 schematically shows details of the stereoscopic viewing device and beams of light in use;

FIG. 3 schematically shows beams of light in a transverse zoom in operation of a transverse zoom in mechanism of the stereoscopic viewing device; and

FIG. 4 schematically shows details of the transverse zoom in mechanism which is adapted to mount at the rear of the stereoscopic viewing device.

### DETAILED DESCRIPTION OF THE INVENTION

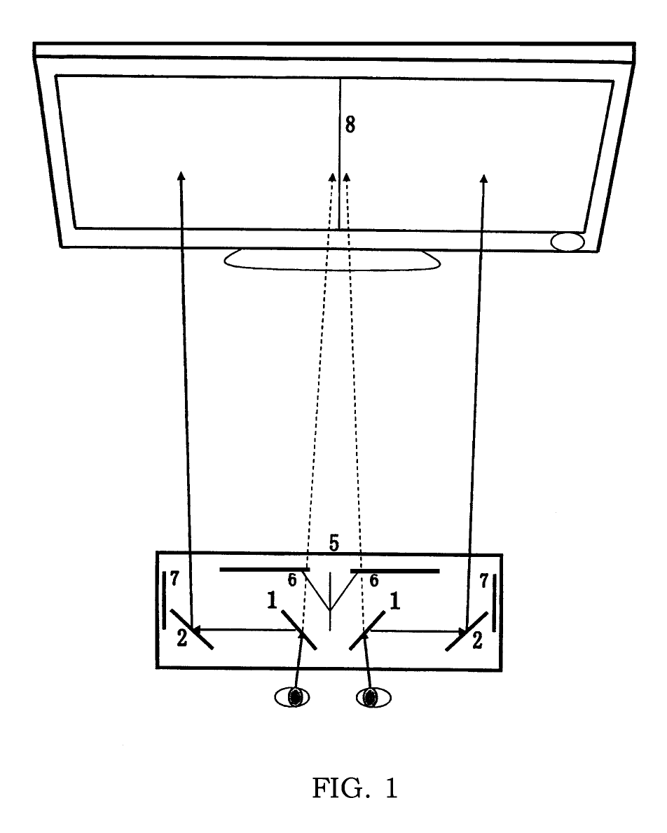

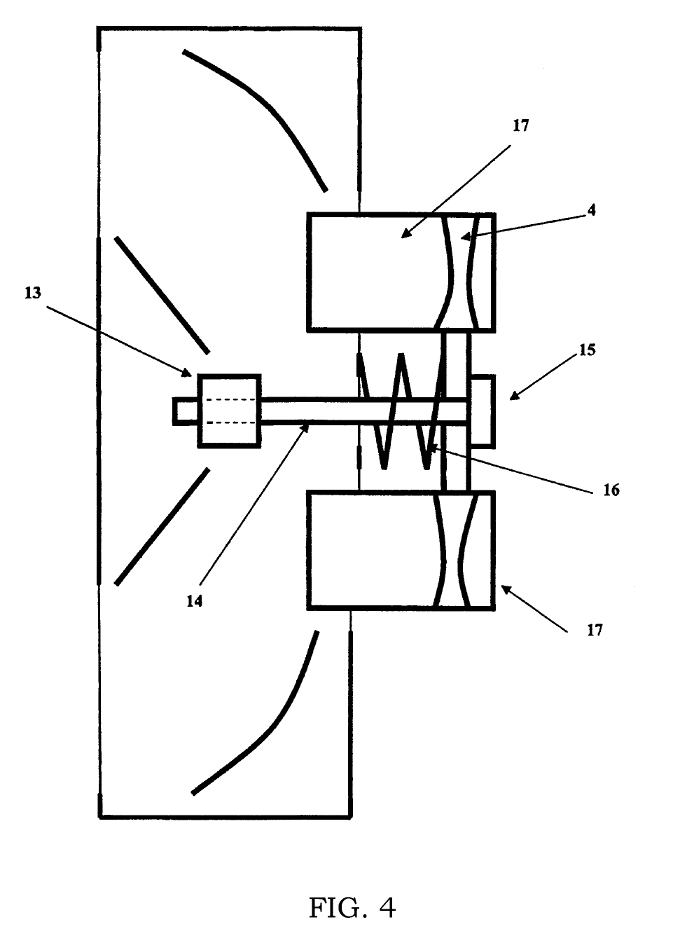

Referring to FIGS. 1 to 4, a stereoscopic viewing device (“viewer”) and a method of displaying stereoscopic images in accordance with invention comprises are illustrated below.

The viewer comprises a shell 5, a central adjustment screw 11, a transverse rack 12, and left and right sections each being a mirror of the other. In either section there are provided a fixed first eyepiece 1, an objective 2, a reflection lens 3, a turn plate 9, and a pinion 10. The reflection lens 3 and the objective 2 are arranged as a plano-concave and are rotatably disposed on the pinion 10. The pinion 10 is rotatably provided on the center of the turn plate 9. Further, the pinion 10 engages the teeth of the rack 12. Furthermore, the adjustment screw 11 engages the teeth of the rack 12.

The eyes of a user may focus on a point at the center of a screen 8 of a flat display with beams of light being shown in dash lines of FIG. 1 in this embodiment. The real beams of light from the eyes to the screen 8 are on left and right portion of the screen 8 respectively as indicated by solid lines in which either beam of light coming from the eye reaching the first eyepiece 1, being reflected by the first eyepiece 1, reaching the objective 2, being reflected by the objective 2, and finally straightly projects onto the corresponding portion of the screen 8.

The viewer further comprises two side shades 7 adapted to slide up or down and two front shades 6 adapted to slide transversely. Thus, the front shades 6 can be used as a sliding cover to block the real beams of light.

Alternatively, two flat displays are disposed side-by-side to form a single large display in other embodiments.

A user may turn the adjustment screw 11 to linearly move the rack 12. And in turn, both the pinions 10 rotate. As a result, the purpose of adjusting angles of the objectives 2 is achieved.

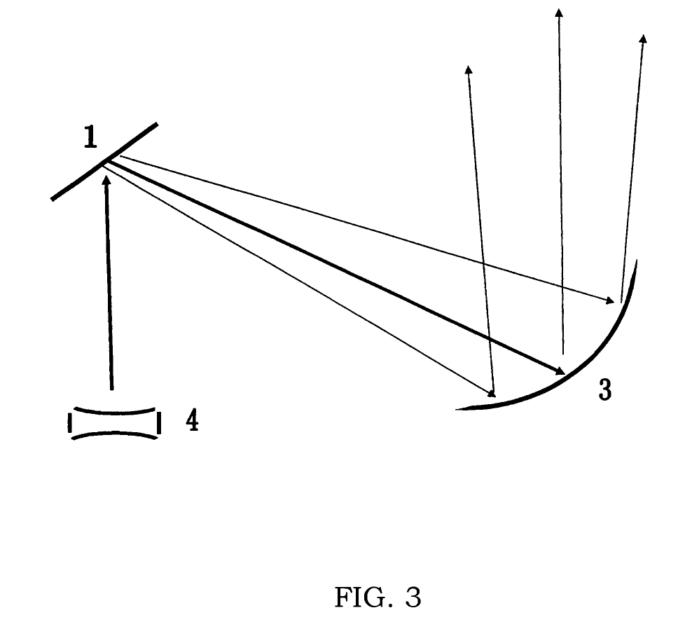

The user may further turn the adjustment screw 11 until the reflection lens 3 faces the first eyepiece 1 directly with the objective 2 being hidden behind as shown in FIG. 3. At this position, the user may perform a transverse zoom in as detailed below.

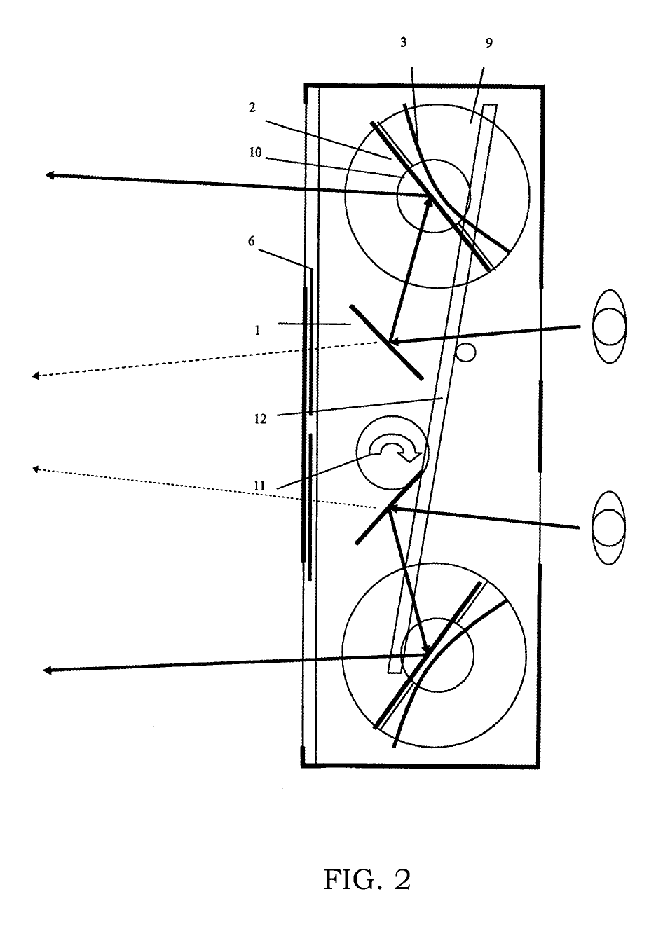

The transverse zoom in mechanism (not numbered) has two rearward projecting hollow cylinders 17 which are adapted to releasably mounted at two rear openings (not numbered) of the stereoscopic viewing device, i.e., the two rear openings each disposed between the eye and the first eyepiece 1 in FIG. 2. The transverse zoom in mechanism further comprises two second eyepieces 4 each mounted in the cylinder 17, a threaded bolt 15 between the cylinders 17, a helical spring 16 biased between the bolt 15 and the rear surface of the viewer, and an internal nut 13 threadedly mounted on the threaded shank of the bolt 15. A user may turn the bolt 15 to simultaneously adjust the focal distances of both the second eyepieces 14. The images shown on the screen of a display can be transversely enlarged by adjusting the second eyepieces 4 until the images can be seen clearly.

The operation of the viewer is similar to that of a binocular. The viewer can be manufactured as a hand held one, a head mounted one, or one mounted on a pedestal.

A method of displaying stereoscopic images in cooperation with a computer picture viewing software by means of the stereoscopic viewing device is illustrated below. A computer monitor screen is divided into left and right slightly spaced apart portions. The gap between these two portions can be adjusted. After running the picture viewing software, a user may choose a picture, for example, on one pan window on the left portion of the computer monitor and the computer then searches the other picture of the same pair of pictures (e.g., one picture file having the same name as the chosen one) from a storage device (e.g., hard disk). Only a picture file having the same name and the same file size as the chosen picture file will be chosen, downloaded into memory of the computer, and shown on the other pan window on the right portion of the computer monitor. These two picture files are stored as a pair of pictures and are given a unique serial number. A plurality of searches can be performed so as to store a plurality of pairs of picture files in the computer. A user may view a 3-D image rendered by a desired one of the pairs of pictures on the display by further operating the viewer and the display. The user may further perform operations such as “flip/rotate”, “next image”, “previous image”, “scrolling”, and playing “slide show” on the computer with its result shown on the display.

An image can be zoomed out if the image shown on the screen is larger than the size of the screen. To the contrary, an image can be zoomed in if the image shown on the screen is smaller than the size of the screen. An image can be centered on the screen if its size is acceptably less than that of the screen (i.e., can be seen clearly). Any zooming in or out operation of either picture will cause the other picture to do the same in order to ensure that both pictures are zoomed in or out at the same time.

Picture movement and thus image movement can be effected through mouse drag or pressing “up”, “down”, “left”, or “right” key on the computer keyboard. Moreover, a picture can be transversely compressed prior to showing on the screen. For example, alternate rows of pixel of a picture are deleted. This feature will decrease the resolution of the rendered image. However, no significant image distortion will occur. For reducing distortion, this transverse compression is done after the image zoom in or out operation.

Alternatively, the two displays can be arranged in a stacked fashion. This feature is applicable to a 3-D stereoscopic glass.

A method of displaying stereoscopic films (e.g., DVD video) in cooperation with a DVD player by means of the stereoscopic viewing device is illustrated below. A single display is employed. Two pictures are shown on left and right portions (i.e., pan windows) of the screen at the same time with a 3-D image being rendered. A synchronous feature is required in this application. Synchronous feature can be implemented as manual or automatic one. For manual synchronism, a halt key is provided in either left or right video playing bar. A user may click the halt key to halt the playing of one picture by manipulating a mouse. At the same time, the other picture is also halted. The halt will end only after releasing the mouse key. Automatic synchronism is effected by adding a time frame in each picture to be played in a camcoder. Time frames of pictures of the same pair are compared each other prior to next playing. Any picture being recorded earlier is required to wait for the other later picture of the same pair. This ensures that both pictures of the same pair are played synchronously in order to render a 3-D image and thus a 3-D film.

While the invention herein disclosed has been described by means of specific embodiments, numerous modifications and variations could be made thereto by those skilled in the art without departing from the scope and spirit of the invention set forth in the claims.

What is claimed is:

1. A stereoscopic viewing device comprising:
a transverse rack;
left and right sections comprising a fixed first eyepiece, a turn plate, a pinion engaging teeth of the track and rotatably disposed on the turn plate, and an objective rotatably disposed on the pinion; and
a first adjustment screw engaging the teeth of the rack,
wherein a first beam of light coming from one of human eyes reaching and being reflected by the first eyepiece of the left section, reaching and being reflected by the objective of the left section, and projects onto a left portion of a display;
wherein a second beam of light coming from the other one of the human eyes reaching and being reflected by the first eyepiece of the right section, reaching and being reflected by the objective of the right section, and projects onto a right portion of the display;
wherein a 3-D image is given to the human eyes when the first and second beams of light project on the display; and
wherein the first adjustment screw is adapted to turn to linearly move the rack which rotates the pinions to adjust angles of the objectives.

2. The stereoscopic viewing device of claim 1, wherein either section further comprises a reflection lens rotatably disposed on the pinion thereof, and wherein the reflection lens and the objective of either section are arranged as a plano-concave.

3. The stereoscopic viewing device of claim 2, further comprising two rear openings and a transverse zoom in mechanism comprising two rearward projecting hollow cylinders adapted to releasably mounted at the rear openings, two second eyepieces either mounted in the cylinder and facing the first eyepiece, and a spring biased second adjustment screw fastened between the cylinders, wherein the plano-concave is adapted to turn to cause its reflection lens to face the first eyepiece of the same section, and wherein the second adjustment screw is adapted to turn to focal distances of the second eyepieces.

4. The stereoscopic viewing device of claim 1, further comprising two front first shades adapted to slide transversely and two side second shades adapted to slide vertically.

5. A method of displaying stereoscopic images on a display in cooperation with a computer and the stereoscopic viewing device of claim 1, comprising the steps of:
(a) dividing a monitor of the computer into first and second portions and a gap therebetween;
(b) running a picture viewing software on the computer;
(c) choosing a first picture from a storage device of the computer and showing same on the first portion of the monitor of the computer;
(d) instructing the computer to search a second picture having the same file name ad file size as the first picture from the storage device;
(e) downloading the first picture and the found second picture into a memory of the computer to record as a picture file with a unique serial number and showing the second picture on the second portion of the monitor of the computer; and
(f) playing one of the picture files and operating the stereoscopic viewing device in cooperation with the computer such that a person viewing the display is able to see a 3-D image being rendered thereon.

6. The method of claim 5, wherein an action of “flip/rotate”, “next image”, “previous image”, “scrolling”, “zoom in”, “zoom out”, transverse compression, “up”, “down”, “left”, “right”, or “slide show” is adapted to be done on the image.

7. The method of claim 6, wherein the transverse compression of the image is done by deleting a predetermined number of rows of pixels of the pictures thereof.

8. The method of claim 5, wherein the first portion of the monitor of the computer is besides the second portion thereof, above the second portion thereof, or under the second portion thereof.

9. The method of claim 5, wherein the gap is adjustable.

10. A method of displaying a stereoscopic DVD film on a display in cooperation with a DVD player and the stereoscopic viewing device of claim 1, comprising the steps of:
(a) adding a time frame in each recorded picture of the film;
(b) comparing the time frames of paired pictures of the film;
(c) causing the picture being recorded earlier to wait for the other picture of the same pair if it is lag in time; and
(d) showing the paired pictures on left and right portions of the display at about the same time such that a person viewing the display is able to see a 3-D image being rendered thereon.
